(19) United States
(12) Patent Application Publication
(10) Pub. No.: US 2018/0362367 A1
(43) Pub. Date: Dec. 20, 2018

(54) AN APPARATUS FOR WATER SUPPLY AND SANITARY PURPOSES

(71) Applicant: ORBITAL SYSTEMS AB, MALMÖ (SE)

(72) Inventors: Amir Mehrdad MAHDJOUBI NAMIN, MALMÖ (SE); Erik SPARRE, MALMÖ (SE); Krister UVNÄS, SÖDRA SANDBY (SE); Rickard NORENSTAM, LÖDDEKÖPINGE (SE); Joakim OSCARSON, VEJBYSTRAND (SE); Tobias SÖDERBERG, HELSINGBORG (SE)

(21) Appl. No.: 16/061,004

(22) PCT Filed: Dec. 9, 2016
(86) PCT No.: PCT/SE2016/051239

§ 371 Date: Jun. 11, 2018

(30) Foreign Application Priority Data
Dec. 11, 2015 (SE) 1551630-5

(51) Int. Cl. C02F 1/32; E03B 1/04; E03B 7/07

(52) U.S. Cl. CPC C02F 1/325; A47K 3/28; E03B 7/074; E03B 1/042

(57) ABSTRACT

The present invention describes an apparatus 1 for water supply and sanitary purposes, wherein the apparatus 1 comprises a light unit 3 intended for neutralisation of organisms in said water flow, and wherein the light unit 3 is arranged in a dockable water treatment chamber 7. Moreover, according to yet another aspect of the present invention there is disclosed an apparatus for water supply and sanitary purposes, where the apparatus 1 comprises a light unit 3 intended for neutralisation of organisms in said water flow, and 10 wherein the light unit 3 is positioned in a tank 20 of the apparatus 1. Furthermore, according to another aspect of the present invention, there is disclosed an apparatus 1 for water supply and sanitary purposes, where the apparatus 1 comprises a light unit 3 intended for neutralisation of organisms in said water flow, said the light unit 3 being an UV LED unit. 1

### FIELD OF THE INVENTION

The present invention relates to an apparatus for water supply and sanitary purposes, such as for allowing for purification and either recycling of water or discarding of water.

### TECHNICAL BACKGROUND

Different types of devices for water supply and sanitary purposes are known. For instance, there are so called hybrid devices allowing for purification and either recycling of water or discarding of water. One example is disclosed in WO2013/095278, which describes a hybrid device for a recirculation shower, allowing purification and either recycling of water or discarding of water, wherein the hybrid device comprises a recirculation loop, a filter system with a nano-filter, at least one filter quality sensor and at least one pre-filter.

One aim of the present invention is to provide an apparatus for water supply and sanitary purposes which is especially beneficial for commercial use, such as in showers in industries and in public operations, e.g. public baths etc.

### SUMMARY OF ONE FIRST ASPECT OF THE PRESENT INVENTION

The latter stated purpose above is achieved by an apparatus for water supply and sanitary purposes, wherein the apparatus comprises a light unit intended for neutralisation of organisms in said water flow, and wherein the light unit is arranged in a dockable water treatment chamber.

The dockable feature implies that the water treatment chamber not only can be docked in and out, but as such is also easy accessible for a user. This feature may be accompanied with other features, such as having a handle to simplify in-docking and out-docking. Moreover, there are great advantages to use a dockable unit in an apparatus for water supply and sanitary purposes. One such is the fact that the dockable feature renders a user to dock and undock the water treatment chamber in an easy way and as such also for the user to replace the light unit source also. As may be understood from above, the apparatus according to the present invention finds great use both for commercial use, such as in public baths, and private use, such as in a residential shower device.

According to one specific embodiment, the apparatus also comprises a transparent protective cover containing the light unit, wherein the transparent protective cover and hence light unit are contained within the dockable water treatment chamber. As may be understood from above, this also implies that the entire water treatment chamber and contained light unit may be undocked so that the light unit may be replaced with a new one. The transparent protective cover may e.g. be of a plastic or glass material, such as quartz glass.

According to yet another embodiment of the present invention, the apparatus also comprises a water flow tube containing all water flow, wherein the light unit is positioned outside of the water flow tube but inside of the water treatment chamber. Even if this alternative is the opposite as the one disclosed above in terms of the positing of the light unit in relation to the water flow inside of the water treatment chamber, also this alternative has a dockable water treatment chamber and implies an increased ease to replace the light unit when needed.

Furthermore, and as understood from above, the light unit is not in direct contact with the water flow. This is to ensure that the light unit is not covered by any possible contaminants in the water flow. Moreover, the light unit may be an UV lamp or any other form of UV unit, e.g. one or more UV LED units.

### BRIEF DESCRIPTION OF THE DRAWINGS

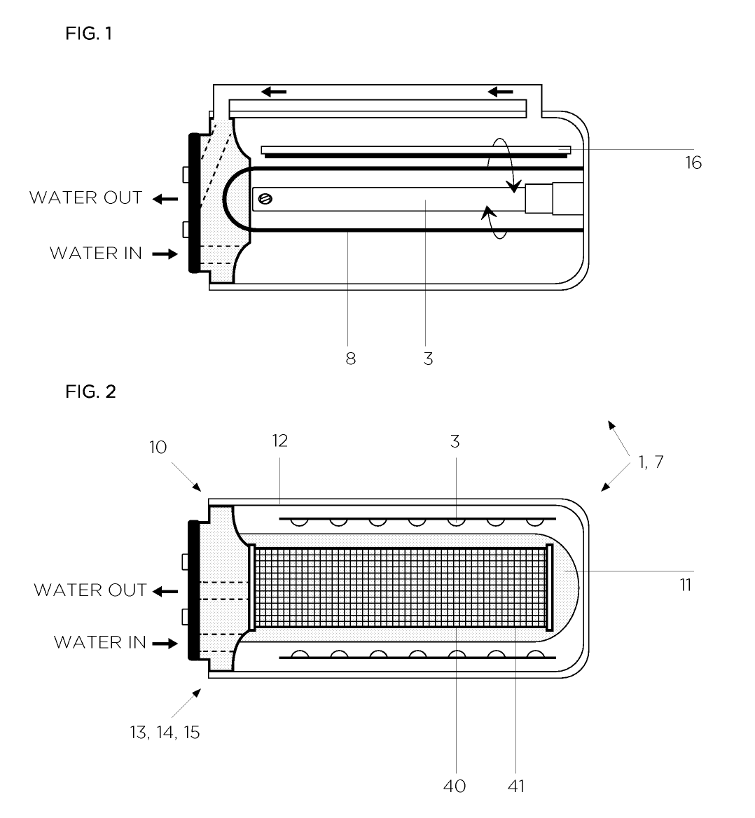

In FIG. 1 there is shown an apparatus for water supply and sanitary purposes according to one specific embodiment of the present invention.

In FIG. 2 there is shown another apparatus for water supply and sanitary purposes according to one embodiment of the present invention.

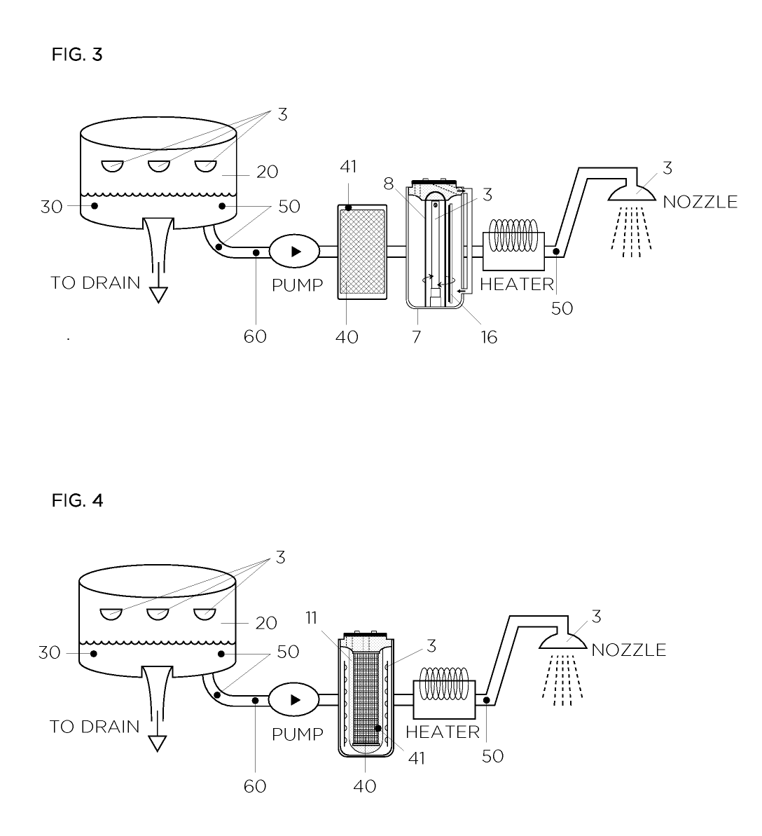

In FIG. 3 there is shown another system, presented as a schematic view, for water supply and sanitary purposes according to yet another specific embodiment of the present invention.

In. FIG. 4 there is shown another system, presented as a schematic view, for water supply and sanitary purposes according to one more embodiment of the present invention.

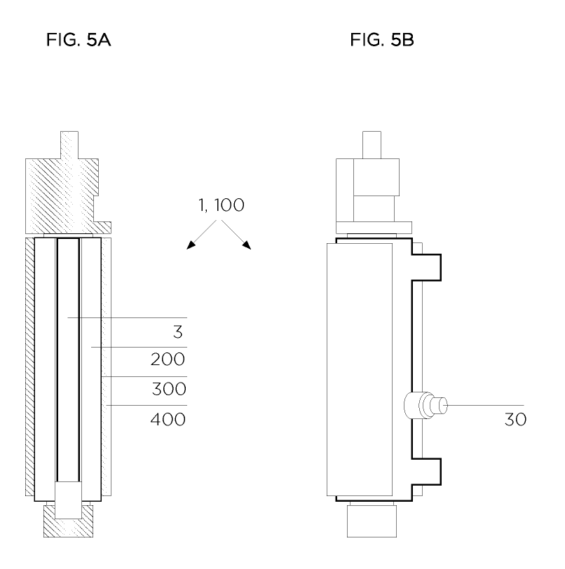

In FIGS. 5A and B there are shown another apparatus for water supply and sanitary purposes according to one embodiment of the present invention, in this case as a combined water heater and water treatment unit.

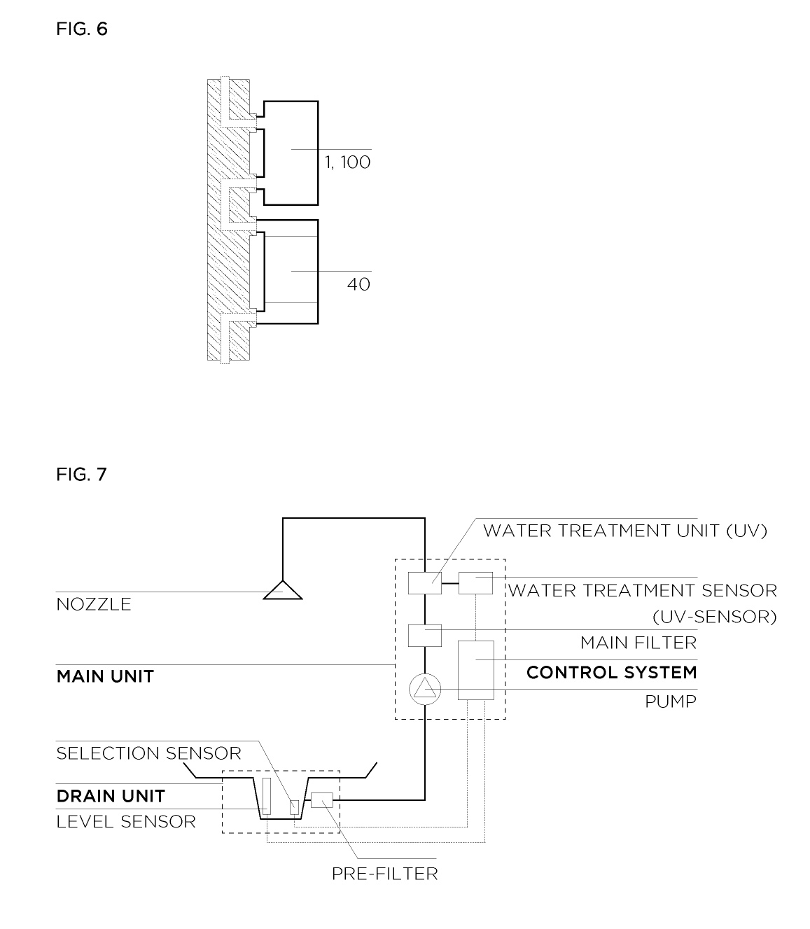

In FIG. 6 there is shown part of a system allowing for purification and recycling of water or separation of water and comprising an apparatus for water supply and sanitary purposes according to the present invention.

Finally, in FIG. 7 there is shown one embodiment of a system allowing for purification and recycling of water or separation of water and comprising an apparatus for water supply and sanitary purposes according to the present invention.

### OTHER ASPECTS AND SPECIFIC EMBODIMENTS OF THE INVENTION

Below other aspects and embodiments of the invention are disclosed and discussed.

According to a second aspect of the present invention there is disclosed an apparatus for water supply and sanitary purposes, wherein the apparatus comprises a light unit intended for neutralisation of organisms in said water flow, wherein the light unit is contained in a capsule comprising
an inner casing which is encasing liquid processing means and the water flow passing the liquid processing means, and which inner casing is open for inflow and outflow of water into and out from the capsule;
an outer unit which has means having a pressure up-taking ability for the inner casing,
   wherein the inner casing and outer unit may be totally separated from each other, and wherein the inner casing may function as a disposable part of the capsule.

The expression “having a pressure up-taking ability” may also be described as “having a pressure withstand capability”.

According to this aspect of the present invention, the light unit may be contained inside of an inner casing, such as a bag, however also in this case then not in direct contact with the water being treated. In such a case, the light unit may be contained inside of a tube or the like. Furthermore, the light unit may also be positioned outside the inner casing/bag. Regardless, this alternative has the benefit of keeping the water flow inside of an inner bag and therefore all contaminants are kept inside of this inner bag.

When an inner casing in the form of a bag is arranged, then this bag may be a disposable bag. In the case of another form of water treatment chamber, then this is only in need of cleaning and not something that has to be replaced. The light unit, however, such as a UV lamp or the like is a disposable that has to be changed when consumed.

Also in these different cases, the light unit may be an UV lamp or any other form of UV unit, e.g. one or more UV LED units.

According to yet another aspect the present invention is directed to an apparatus for water supply and sanitary purposes, wherein the apparatus comprises a light unit intended for neutralisation of organisms in said water flow, and wherein the light unit is positioned in a tank of the apparatus.

The light unit may be positioned differently in the tank, but still without being in contact with the water. Regardless, to place the light unit in a tank may have several advantages. First of all, the tank may be easy to clean from build up of dirt or contaminants, and already in this aspect to place the light unit in the tank may be beneficial. Furthermore, the light unit may also be placed in the upper part of the tank so that the light unit illuminates the whole content of the tank, but still without being in contact with the water as such. In such a setup, then dirt or contaminants that otherwise could block the illumination when getting into contact with the light unit cover is not problematic for the light treatment.

Moreover, also in the case of a light unit in the tank there may be a cleaning unit arranged in the tank. This is further discussed below.

Another advantage of arranging the light unit in the tank is related to placing this treatment unit in a low water pressure zone of the apparatus. This may be an advantage as this enables to design the system more broadly without the need of managing high pressures. One such possible example is to use a comparatively thinner transparent cover glass surrounding the light unit.

According to yet another specific embodiment of the present invention, there is provided an apparatus for water supply and sanitary purposes, said apparatus comprising a light unit intended for neutralisation of organisms in said water flow, wherein the light unit is positioned in a combined water heater and water treatment device. This embodiment is clearly shown in FIGS. 5A and B.

According to one specific embodiment of the present invention, the light unit is embedded by a single container of the combined water heater and water treatment device. According to yet another embodiment, the combined water heater and water treatment device also comprises a heater element arranged on the outside of the single container of the combined water heater and water treatment device. Furtermore, accoridng to one embodiment the light unit is a UV lamp being surrounded by a transparent protective cover and where both the UV lamp and the transparent protective cover are removable from the bottom of the single container.

According to yet another specific embodiment of the present invention, the heater element is one coherent single unit. Furthermore, according to one embodiment the heater element is embedded in isolation. Furthermore, the heater element may be a film attached to a portion of the outside surface of the single container.

According to yet another aspect of the present invention, the apparatus comprises a light unit intended for neutralisation of organisms in said water flow, wherein the light unit is an UV LED unit. Such an UV LED unit can be placed in the tank, such as disclosed above, or in different arrangements in the apparatus. One example is in the nozzle of a shower unit.

To use regular UV lamps in water sanitary devices are known. For instance in WO2009/147647 there is disclosed a water recycling system using a combination of an optical detector to detect certain smaller sized contaminants and a filter to remove larger sized contaminants. The apparatus disclosed may comprise a disinfection unit that kills bacteria in the recycled fluid and this disinfection unit may be an UV lamp.

The light unit according to the present invention, at least in some aspects thereof, may also be an UV lamp or unit. For instance, in a dockable water treatment chamber according to the present invention, the light unit may be an UV lamp. The light unit may also be an UV LED unit or lamp in all aspects of the present invention.

As mentioned above, the present invention is directed to an apparatus for water supply and sanitary purposes. According to all aspects of the present invention, the apparatus may be arranged to allow for purification and either recycling of water or discarding of water.

Furthermore, and as hinted above, the light unit is arranged to be free from contact with any water in the apparatus.

The apparatus may also comprise other units. According to one specific embodiment, the apparatus also comprises a light unit quality sensor. This sensor may be of many different types, for instance a sensor measuring the light intensity. Another sensor type is such which may detect UV light, which is suitable to incorporate when the light unit is a UV light unit. Moreover, the light unit quality sensor may be placed on the bottom of a tank to measure the level of light penetrated through the entire tank and thus water contained therein.

Moreover, the apparatus may also comprise a filter unit. The filter unit may be an additional unit, such as a micron filter. The filter unit may be a pre-filter. Moreover, the filter unit may also be in one and the same unit as the light unit. Such a light and filter unit may also be arranged in a system also having a pre-filter unit. Furthermore, not only a light unit quality sensor may be part of the apparatus, also a filter unit quality sensor may be comprised. As some examples, the filter unit quality sensor may be a pressure meter, pressure switch or a flow meter but can also be a combination thereof or another type of sensor. Another possible example is an optical sensor.

According to yet another specific embodiment of the present invention, the apparatus has a water inflow unit and water outflow unit positioned in the same end of the water treatment chamber. Such an alternative may be seen in FIG. 2 and referred to as “bag-in-tube”. It is important to understand that also a regular water inlet in one end and water outlet in the other end, as shown in FIG. 1 is totally possible according to the present invention. This is totally dependent on type of device according to the present invention.

As hinted above, according to one specific embodiment of the present invention the apparatus also comprises a filter unit and where the filter unit and the light unit are positioned in connection to one another. One example of such an embodiment of the present invention is to arrange a disposable bag in an outer casing. The bag is transparent. On the bag there is provided one or more light units, such as e.g. a strap of UV LED units. In such a bag all of the water treatment by the light unit is performed inside of the bag. Furthermore, liquid processing means in the form of a filter may be contained in the bag. This implies that both UV treatment and filtering may be performed in one and the same bag or inner casing. Moreover, the inflow and outflow is in one and the same end in such an arrangement according to the present invention.

According to yet another specific embodiment of the present invention, the light unit comprises a cleaning unit intended for cleaning of the outside of the transparent protective cover or inside of the water flow tube. The cleaning unit may clean during regular use, such as driven by the flow, or during a cleaning cycle so there is no need for opening the apparatus and then clean afterwards. Moreover, the cleaning unit will clean a surface so the risk of contamination on that surface is decreased. There are many possible different alternative cleaning units. Some examples are wipers or rotating units, e.g. brushes or scrapers. In relation to the cleaning unit is important to understand that this in an option according to the present invention however it is not a unit of interest to incorporate in some of the embodiments.

Also the controlling features may be of interest according to the present invention. According to one specific embodiment of the present invention, the light unit is controllable in relation to light intensity. This may be of interest to increase the life span of the light unit. As an example, the intensity of the light unit may down-regulated when the light unit is not intended for operation. However, to totally turn it off is not necessarily a better choice for the light unit as every off and on cycle on such a light unit may affect the life span negatively. However, to control the light intensity of the light unit may be a good way to prolong the life span.

According to yet another specific embodiment, the flow of water is regulated based on the value outcome from the light unit quality sensor. This may be a setup where e.g. a low or bad value for the functionality of the light unit may be controlled if it is accurate or not. Furthermore, it is also a possible arrangement for regulating the apparatus based on the value of the light unit quality sensor. As an example, the flow of water may be decreased as a response to a low value, i.e. with a decreased light intensity then the water flow is also decreased. This low value may in turn e.g. be an effect from foam production in the water flow when a user is shampooing in a shower according to the present invention. Then an increase in water flow may be a way of overcoming the problem of foam blocking the light unit treatment. Furthermore, the apparatus according to the present invention may also comprise a turbidity sensor and/or a foam sensor.

Moreover, it should be mentioned that the regulation may be directed to both increasing and decreasing the water flow in the apparatus according to the present invention as a response to a low or bad value from the light unit quality sensor. For instance a decreased water flow may be of interest when the light unit treatment does not seem to be enough to get the intended dose. With a decreased water flow, then all bacteria have a greater residence time in the light unit treatment. To use such an approach may be of interest when the light unit, e.g. an UV lamp, is starting to have decreased effect, if the water is turbid or if there is fouling on the cover glass outside of the light unit.

Moreover, according to yet another specific embodiment of the present invention, the apparatus comprises at least one water quality sensor. Furthermore, the light unit quality sensor and the at least one water quality sensor may be arranged to be in communication with each other in a control system of the apparatus. Such a setup may link the light unit sensor to a water quality sensor, the latter e.g. being an electric conductivity (EC) sensor. Also in this case it may be of interest to link this to the effect of the light unit, possible fouling of a surface outside of the light unit, i.e. where the water flows, as well as the water quality as such. According to one example is incorporating a light sensor which may detect/measure different wave lengths.

The present invention also relates to a method for controlling or regulating an apparatus according to the invention. According to one embodiment of the present invention, the system choice of recycling of water or discarding of water is linked to a value received from the light unit quality sensor. This implies that there are regulation data logics between a water quality sensor and the light unit sensor, also possibly to the optional foam sensor. One possibility is to use regulation basics linked to the derivative of the value of the light unit sensor.

According to yet another specific embodiment of the present invention, a value received from the light unit quality sensor is linked to a possible response of decrease in water flow and/or injection of water flow via a control system of the apparatus. As explained shortly above, this regulation may be a response to an indication from a foam sensor when a user has used excessive amounts of shampoo in a shower according to the present invention.

According to yet another specific embodiment of the present invention, light being used has a wavelength so that ozone is produced in the air which then is flowed into the water, which ozone containing water is used for disinfection, e.g. for anti-microbial effect, chemical degradation of surfactants or perfume substances, and/or cleaning parts of the apparatus. At a certain range of wavelength, e.g. around 185 nm, ozone is produced in the water. This ozone may be produced at times when e.g. a shower or another type of apparatus according to the present invention is used or when it is not in normal use, for instance, night time. Then the apparatus or shower may be in cleaning cycle mode. The production occurs when the UV lamp is illuminating.

One alternative is to incorporate a combination of different light units, such as several UV LED units, illuminating with different wavelengths so that at least one is intended to be used for the treatment and another one for ozone production.

### DETAILED DESCRIPTION OF THE DRAWINGS

In FIG. 1 there is shown an apparatus 1 for water supply and sanitary purposes according to one specific embodiment of the present invention. The apparatus 1 comprises a light unit 3 in the form of an UV lamp intended for neutralisation of organisms in the water flow. Furthermore, the light unit 3 is arranged in a dockable water treatment chamber 7. The apparatus 1 also comprises a transparent protective cover 8 containing the light unit 3, and the transparent protective cover 8 and hence light unit 3 are contained within the dockable water treatment chamber 7. Furthermore, a cleaning unit 16 in the form of a wiper is arranged to clean the outside of the transparent protective cover 8. Moreover, as seen in FIG. 1 the water inlet and water outlet is at the same side the unit.

In FIG. 2 there is shown another apparatus 1 for water supply and sanitary purposes according to another embodiment of the present invention. This alternative may be called a “bag-in-tube”. In this case the light unit 3 is a UV LED unit provided as several LED lamps provided outside of an inner casing 11 in the form of a bag in this case. The entire apparatus 1 comprises a capsule 10 with the bag 11 encasing liquid processing means in the form of a filter unit 40. Furthermore, outside of the bag 11, the light unit 3 is arranged. Outside of this, an outer unit 12 which has means having a pressure up-taking ability (pressure withstand capability) for the bag 11 is arranged. In this case it may be noted that the apparatus 1 has a water inflow unit 13 and water outflow unit 14 positioned in the same end 15 of the water treatment chamber 7.

In FIG. 3 there is shown another system and apparatus for water supply and sanitary purposes according to yet another specific embodiment of the present invention. In this case there is shown a schematic view of a system which shows many different alternatives according to the present invention. In this case the system, from left to right, comprises a tank 20 which may have light units 3. As such there may also be provided a light unit quality sensor 30. As understood from FIG. 3, additionally or only there may also be one or several light units 3 provided in a dockable water treatment chamber 7, in this case shown as a single unit having a transparent protective cover 8 and a cleaning unit 16 in the form of a brush rotating around and cleaning the outside of the transparent protective cover 8. A separate filter unit 40 with a filter quality sensor 41 are also shown. As mentioned above, this may be integrated as one single unit together with a light unit 3 in a dockable water treatment chamber 7, however in this case it is provided as a separate unit. Furthermore, it is also shown where the flow might be directed to the drain, the use of a heater and also the nozzle. The nozzle may be the nozzle of a shower but can also be another type of device for water supply and sanitary purposes, such as e.g. a sink. As notable in the nozzle, this may also be provided with a light unit 3, which may be an UV LED unit 3. In relation to this it is important to understand that such a light unit 3 is optional and may not be provided in a system according to the present invention. Moreover, a system according to the present invention may have one or more UV LED units 3 provided in the nozzle, and such light unit(s) 3 may be the only one(s) in the system. Consequently, the examples shown in FIGS. 3 and 4 show many different versions of different embodiments according to the present invention. In the FIGS. 3 and 4 several versions of systems according to the present invention are shown in one and the same schematically depicted figures.

Furthermore, the system is typically a system allowing for purification and either recycling of water or discarding of water, where the latter is flowing the water to the drain. In addition to the light unit quality sensor 30, which also can be provided in connection with the other possible light units 3, there may also be arranged a filter quality sensor 41 in connection with a filter unit 40 and one or more water quality sensors 50. These may be provided as ne sensor or several ones at different places in the system. Furthermore, a foam sensor 60 may also be arranged in the system.

In FIG. 4 there is shown another system and apparatus for water supply and sanitary purposes according to yet another specific embodiment of the present invention. In this case the system comprises a “bag in tube” such as according to FIG. 2. As notable this “bag in tube” unit comprises a capsule 10 with a bag 11 encasing liquid processing means in the form of a filter unit 40. Furthermore, outside of the bag 11, the light unit 3 is arranged such as according to shown in FIG. 2.

FIG. 5A shows an apparatus 1 or water supply and sanitary purposes according to one specific embodiment of the present invention. The apparatus 1 comprises a light unit 3 positioned in a combined water heater and water treatment device 100. The combined water heater and water treatment device 1 comprises a single container 200 and a heater element 300, in this case in the form of a heater film, arranged on the outside of the single container 200 of the combined water heater and water treatment device 100. Furthermore, the heater element 300 is embedded in isolation 400.

Moreover, as shown in FIGS. 5A and 5B the light unit 3 is in the form of a UV lamp. Furthermore, and as seen in FIG. 1B there is provided a UV sensor 30 (light unit quality sensor) to detect the light penetration through the water in the single container 200.

FIG. 6 shows part of a system comprising an apparatus 1 for water supply and sanitary purposes and allowing for purification and recycling of water or separation of water, wherein said system comprises the apparatus 1 in the form of a combined water heater and water treatment device 100 placed above a water filter unit 40 in terms of process flow.

FIG. 7 shows a full system comprising an apparatus 1 for water supply and sanitary purposes (mentioned as water treatment unit) and allowing for purification and recycling of water or separation of water, in this case a shower. The system comprises a main unit comprising a combined water heater and water treatment device 1, 100 (mentioned as water treatment unit) and a main filter. As notable, the water treatment unit has a water treatment sensor which is connected to a control system. Other sensors in the system are sensors in the drain of the system. These are also connected to the control system. As such it is possible to integrate several sensors.

As an example, the system comprises a combined water heater and water treatment unit 1, 100 comprising a UV unit 3, which water treatment unit 1, 100 is connected to a UV sensor. Moreover, the system also comprises a filter system comprising a main filter being a mid/fine filter and a pre-filter, e.g. a removable mesh filter. Furthermore, a pump, control system, nozzle (and/or handheld shower) and of course piping is also arranged in the system. In the drain unit, there are provided a second sensor type being a main “selection sensor”, selection referring to the selection of recirculating or separation of water, and also a third sensor type being a level sensor. Both of these sensors are also connected to the control system.

1. An apparatus for water supply and sanitary purposes, wherein the apparatus comprises a light unit intended for neutralisation of organisms in said water flow, and wherein the light unit is arranged in a dockable water treatment chamber.

2. An apparatus according to claim 1, wherein the apparatus also comprises a transparent protective cover containing the light unit, wherein the transparent protective cover and hence light unit are contained within the dockable water treatment chamber.

3. An apparatus according to claim 1, wherein the apparatus also comprises a water flow tube containing all water flow, wherein the light unit is positioned outside of the water flow tube but inside of the water treatment chamber.

4. (canceled)

5. (canceled)

6. (canceled)

7. (canceled)

8. (canceled)

9. (canceled)

10. (canceled)

11. (canceled)

12. (canceled)

13. (canceled)

14. An apparatus according to claim 1, wherein the light unit is an UV lamp or an UV LED unit.

15. (canceled)

16. An apparatus according to claim 1, wherein the apparatus is arranged to allow for purification and either recycling of water or discarding of water.

17. (canceled)

18. An apparatus according to claim 1, wherein the apparatus also comprises a light unit quality sensor.

19. An apparatus according to claim 1, wherein the apparatus also comprises a filter unit.

20. (canceled)

21. (canceled)

22. (canceled)

23. (canceled)

24. (canceled)

25. An apparatus according to claim 16, wherein the flow of water is regulated based on the value outcome from the light unit quality sensor.

26. An apparatus according to claim 1, wherein the apparatus comprises at least one water quality sensor (50) and wherein the light unit quality sensor and the at least one water quality sensor is in communication with each other in a control system of the apparatus.

27. (canceled)

28. An apparatus according to claim 1, wherein the apparatus also comprises a turbidity and/or foam sensor.

29. A method for controlling an apparatus according to claim 1, wherein the system choice of recycling of water or discarding of water is linked to a value received from the light unit quality sensor and/or wherein a value received from the light unit quality sensor is linked to a possible response of decrease in water flow and/or injection of water flow via a control system of the apparatus.

30. (canceled)

31. A method for controlling an apparatus according to claim 1, wherein light being used has a wavelength so that ozone is produced which then is flowed into the water, which ozone containing water is used for disinfection and/or cleaning parts of the apparatus.

32. An apparatus for water supply and sanitary purposes, wherein the apparatus comprises a light unit intended for neutralisation of organisms in said water flow, and wherein the light unit is positioned in a combined water heater and water treatment device.

33. An apparatus according to claim 32, wherein the light unit is embedded by a single container of the combined water heater and water treatment device.

34. An apparatus according to claim 33, wherein the combined water heater and water treatment device also comprises a heater element arranged on the outside of the single container of the combined water heater and water treatment device.

35. An apparatus according to claim 32, wherein the light unit is a UV lamp being surrounded by a transparent protective cover and wherein both the UV lamp and the transparent protective cover are removable from the bottom of the single container.

36. An apparatus according to claim 34, wherein the heater element is one coherent single unit.

37. An apparatus according to claim 34, wherein the heater element is embedded in isolation.

38. An apparatus according to claim 32, wherein the heater element is a film attached to a portion of the outside surface of the single container.

39. An apparatus for water supply and sanitary purposes, wherein the apparatus comprises a light unit intended for neutralisation of organisms in said water flow, and wherein the light unit is an UV LED unit.
